(19) United States
(12) Patent Application Publication
(10) Pub. No.: US 2024/0029167 A1
(43) Pub. Date: Jan. 25, 2024

(54) Method and System for Enrolling in Health Insurance

(71) Applicant: True Health Connect LLC, Pembroke Pines, FL (US)

(72) Inventors: Amari Batista, Pembroke Pines, FL (US); Amanda Roche, Miami, FL (US)

(73) Assignee: True Health Connect LLC, Pembroke Pines, FL (US)

(21) Appl. No.: 18/193,621

(22) Filed: Mar. 30, 2023

Related U.S. Application Data
(60) Provisional application No. 63/362,195, filed on Mar. 30, 2022.
(60) Provisional application No. 63/371,417, filed on Aug. 15, 2022.

(51) Int. Cl. G06Q 40/08

(52) U.S. Cl. CPC G06Q 40/08

(57) ABSTRACT

Methods and a system allow consumers of healthcare to select an independent insurance agent from a set of independent insurance agents and to request offers for health insurance policies from the independent insurance agents. The methods and systems obviate lead generating firms by allowing the consumer to select their independent insurance agent based on a criterion chosen by the consumer. The consumer sends personal contact information and healthcare information (i.e., a medical history) to the selected independent agent. The consumer does not send information to the system. Accordingly, unselected agents cannot contact the consumer. Because the insurance agent is an independent insurance agent, offers for health insurance can include policies from different underwriters. The methods and system provide for the consumer being added to do not call lists by default. The methods and system collect consumer protection compliance information from the consumer. The system utilizes a downloadable software application.

### CROSS-REFERENCE TO RELATED APPLICATIONS

This application claims the benefit of U.S. Provisional Application No. 63/362,195, filed Mar. 30, 2022, and U.S. Provisional Application No. 63/371,417, filed Aug. 15, 2022, both of which are incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The invention relates to methods for enrolling applicants in insurance policies, and more particularly, health insurance policies.

### Description of the Related Art

### Insurance Terminology

Health insurance is sold through a hierarchy of entities. The following is an explanation of some commonly used terms in the insurance industry. Four acronyms are used to describe insurance marketing agents (IMAs) that independent insurance agents can partner with to do business: FMO, IMO, MGA, and GA. The hierarchy of the groups is insurance carriers>FMO (Field Marketing Organization)>IMO (Independent Marketing Organization)>MGA (Managing General Agent)>GA (general agent).

A field marketing organization (FMO) is basically the same as an independent marketing organization (IMO). FMOs are typically top-level organizations that are licensed to sell health insurance products in most, if not all, states. They work with hundreds to thousands of agents and multiple big-name and small-name carriers across the U.S. Almost all of an FMO's contracts are direct with carriers, and FMOs are usually able to offer agents contracts that provide higher than street-level commissions. In general, FMOs also offer agents a lot of other perks they cannot get elsewhere.

While FMOs focus on health insurance products, they may also offer contracting for life insurance products or other types of ancillary insurance coverage. Agents who work with an FMO may have production requirements they have to meet to maintain their commission levels. It's also worth noting that agents who partner with an FMO and later wish to leave the organization will have to get a release from the FMO.

An independent marketing organization (IMO) is basically the same as an FMO. Some agents believe FMOs tend to focus more on health insurance products while IMOs tend to focus on life insurance products, but this isn't always true. IMOs are sometimes a little smaller than FMOs and may not be able to pay agents as much in commission as some FMOs.

Like FMOs, IMOs tend to be licensed to sell multiple carrier products in multiple states. They work with hundreds to thousands of agents, and usually offer those agents valuable training and support.

Managing general agents (MGAs) may partner with FMOs and/or IMGs, though typically as a downline of those top-of-hierarchy organizations. They also have their own downline agents, who they help with their businesses. MGAs earn more commission than a general agent, but less than an FMO/IMO. They oftentimes are required to reach and maintain certain production requirements to keep their status as an MGA. These requirements can vary from one FMO or IMO to another, and even from one carrier to another.

The MGA term is more widely recognized with life insurance agencies. Some MGAs may call themselves brokerage general agencies (BGAs), which is also a common term on the life side of business. Sometimes, MGA/BGA can be a top-level contract. In fact, the MGA/BGA contract is the top contract offered by life insurance carriers.

Good MGAs/BGAs will provide their downline agents training and support, even as much as an FMO/IMO/NMO.

General agents (GAs) may contract under an FMO, IMO, NMO, or MGA. This contract typically allows them to have their own sub-agents and likely has production requirements an agent needs to meet to maintain their status as a GA.

Like good MGAs, good GAs will provide their agents with some training and support, but likely not on the same level as an FMO/IMO. Again, this is simply because they don't have as many resources as the larger organizations (i.e., time, money, staff members, etc.).

A healthcare consumer (“consumer”) is a person who utilizes healthcare services and who purchases healthcare insurance to cover costs of the healthcare services. Consumer is a term that can include the policy holder and additional beneficiaries. Before a consumer purchases a health insurance policy, an IMA will refer to a consumer as a lead or potential customer. After purchasing the health insurance policy, the IMA will refer to the consumer as a customer or client.

Actors and entities in the insurance and health insurance marketplace (agents, agencies, carriers, consumers/beneficiaries) cannot presently engage on a mobile application to complete the enrollment process in a simple and integrated platform. Furthermore, there are challenges such as efficiency, quality lead-generation, churn, retention, and Telecommunications Consumer Protections (TCP) issues, which increase costs for all parties (and ultimately consumers), decrease consumer satisfaction, increase insurer risk, and decrease agent cash flow.

### Method for Enrolling Consumers

A typical method for enrolling customers in health insurance policies occurs as follows. A (sales) lead generation firm (hereinafter, “firm” or “LGF”)) hosts an event (i.e., a meeting, party, social event) for consumers. For example, the firm could host an event for residents in a retirement community. At the event, the firm requests the customers to provide their customer information (e.g., name, telephone number, email address, mailing address, and social media handle) and to give their consent to be contacted by an insurance agent. Following the event, the firm sells the customer information to an insurance agent.

In an alternate method, the firm hosts and markets a website promoting health insurance coverage. Potential customers seeking insurance coverage submit their contact information and possibly health information (e.g., age and medical history). Next, the firm sells the customer information to insurance agents and insurers for the highest price. It is important to note that the firm itself is typically not qualified to sell the insurance itself.

In either case, the firm sells the lead based on the highest price, which is not necessarily the best coverage or price for the customer. The insurance agent contacts the potential customer and solicits the customer. During the solicitation, the insurance agent collects health information from the potential customer. In the same conversation, the insurance agent provides the potential customer with any required consumer protection information. Next, the insurance agent provides the customer information and the health information to an insurer (i.e., underwriter). The insurer replies to the insurance agent with an appropriate health insurance policy and an annual price. In turn, the insurance agent provides the potential customer with the terms of the insurance policy and a premium (i.e., price). If the customer accepts, the insurance agent enrolls the potential customer in the policy and arranges a payment schedule that includes a downpayment followed by monthly payments to be paid by the potential customer to the insurer. The insurer rebates the insurance agent with a portion of the premium. The rebate to the insurance agent may pass through IMAs before reaching the insurance agent. The insurance agent is paid a commission on the premium even if the premium is being paid in installments. If the customer cancels the policy, the insurance agent returns a prorated commission upstream.

This process has many shortcomings. The following are examples.

The firm sells a given lead to an insurance agents based on the highest price. The winning insurance agent may not be affiliated with an insurer that can offer the best policy for the potential customer.

The firm only agrees to sell the lead exclusively for ninety days. After ninety days, the firm will resell the lead to a second insurance agent, even if the first agent already converted the lead to a customer. The second insurance agent will offer a different policy at a different price. If the customer accepts the second offer, the customer will cancel the first policy. When the insured cancels the first policy, the insurer requests a charge back from the first agent for the portion of the policy that the insured canceled. This process exposes the insured to repeated sales calls, which lower the customer's satisfaction. In addition, the process unexpectedly reduces the cash flow of the insurance agent.

To protect consumers from unethical insurance agents, the government has passed consumer protection laws. The consumer protection laws provide civil penalties for violations. Attorneys who represent customers/insureds win penalties from insurers when the insurer or insurance agent violate the law. To protect themselves, insurers and insurance agents provide the required notice and disclaimers that are required by the law to the customers/insureds. The insurance agent and insurer note the customer's consent to the disclaimers. Later, when the customer consults with an attorney, the customer may not remember that they had been given the necessary disclaimer. If litigation for violation of the consumer protection law ensues, the insurance agent, who acted within the requirements of the consumer protection law, only has the weak, self-serving evidence of their own notes as a defense.

### Healthcare Insurance Software Platforms

A software platform for enrolling applicants into health insurance policies is sold under the trademark SUNFIRE. The software platform is accessed by an applicant or agent by using an internet browser. The software platform can be accessed on smart devices such as smartphones, tablet computers, or computer kiosks. The software platform is purpose-built to create a more seamless, reliable enrollment experience for agents, brokers, and customers alike. The platform allows agents to enroll Medicare patients in insurance policies. The platform allows agents to enter the customer's doctors and see the network status across all plans. The platform offers a full suite of e-signature options including text for signature is often a faster, more convenient option to complete an enrollment or scope of appointment. The platform provides notifications, which allow agents to receive updates on enrollments (especially useful when not completed in-person) via the ‘Notifications’ panel in the system, with both email and text. The platform can be used to quickly access personal benefits, highlights, plan overview, doctor/hospital coverage and additional plan coverages all in one, easy-to-understand view. The platform provides carrier approved plan data, which assures that data used by the platform is carrier sourced and carrier approved each season. The platform offers ready-to-sell processing, which offers the option of automating the entire, ever-changing carrier Ready-To-Sell data, increasing reliability, enhancing compliance, and reducing cost. The platform offers preferred pharmacy finder, which includes a simple-to-use mapping tool that makes it easy to find savings at preferred pharmacies by plan. The platform provides a LIS Calculator, which enables customers eligible for extra help to automatically adjust the premium and co-pays to reflect their actual out-of-pocket costs for each plan. The platform offers e-Commerce capability optimized for senior usability, which improves conversion of leads. The platform offers saved session codes, meaning collected drug and health information, needs to be entered once and is saved in perpetuity, even if customer enters data online. The platform offers Comparisons vs. current plan enables customers to compare rates and benefits of their current plan with those of upcoming plans. The platform offers one, consistent enrollment flow that streamlines the experience for agents and customers alike.

Another platform offers customer relationship management functions to insurance salespeople under the trademark YOUR MEDICAL RESOURCES. The platform offers both quoting platforms. The platform allows users to obtain carrier certifications and carrier instructional guides. The platform allows users to access proprietary Medicare supplement products. The platform provides compliance bulletins and notices. The platform provides users with basic and advanced Medicare training. The platform provides discount certifications. The platform provides leads to users. The platform provides its users with access to discounted E&O Insurance.

A platform for customers (i.e., potential insureds) to purchase health insurance is available under the trademark HEALTHSHERPA. The platform attempts to ease the health insurance enrollment process. The platform allows customers to see the most affordable plans, compare plans, and get enrolled fast. The platform provides an alternate interface to the US Federal Governments official marketplace offered under the Affordable Care Act (ACA). The platform provides a custom plan recommendation emphasizing affordability and fulfilling patient needs. The platform explains the details of the coverage and tries to avoid insurance jargon. The platform shows which plans the patients' doctors and hospitals accept. The portal shows how much each plan pays towards the patient's prescription drugs. The portal provides a total cost estimate based on your expected healthcare use.

The platforms typically can be accessed in three scenarios: 1. Visiting an agency; 2. visiting a point-of-sale location; and 3. Tele-sales.

The tele-sales process can work as follows. A client enters his or her customer information online. Next, the client's customer information is sold to multiple agents. The various agents contact the customer. A flood of calls can lead to legitimacy issues. Swamped customers often will turn to excluding agents completely by adding their telephone number to the Do Not Call List. The tele-sales process presents issues with compliance, product selection, privacy and security, language barriers, and staffing.

The hours of operation are limited in point of sales locations. Generally, point of sales locations are open between 9 AM and 9 PM.

Staffing is inadequate because many employees limit their total weekly work hours to twenty.

Two related problems with prior art enrollment systems are churn and retention. Lead generating services, which are also referred to as “publishers” are allowed to resell leads ninety days after a prior sale. Publishers can bait and switch already-enrolled customers with teaser offers that are not available. If a customer changes policies, then the former carrier will require a refund or charge back of annual commission from the prior agent.

Accordingly, a need exists in consumers to be able to find health insurance coverage from the best qualified and best priced agents based on the potential customer's preferences.

A further need exists to connect potential customers with qualified agents and insurers while removing the cost and annoyance of lead generating firms.

A further need exists for a system that records a potential customer's acknowledgement of disclaimers from the insurance agent or insurer to protect the insurance agent and insurer from mistaken consumer protection claims.

### BRIEF SUMMARY OF THE INVENTION

An object of the invention is to provide a method for enrolling in insurance, a kiosk for enrolling in insurance, and a computer software product for enrolling in health insurance that overcomes the disadvantages of the devices and methods of this general type and of the prior art.

The method according to the invention can be used by customers seeing individual and/or group insurance coverage.

With the foregoing and other objects in view there is provided, in accordance with the invention, a downloadable software application for self-service enrollment for insurance, and particularly for health insurance. The software application includes a method with the following steps. A consumer/beneficiary engages with an agent, agency, or carrier of the consumer/beneficiary's choosing. The consumer/beneficiary engages the agent, agency, or carrier with the consumer/beneficiary's own mobile device (e.g., smartphone or portable computer). An alternative to the consumer/beneficiary's own mobile device is for the consumer/beneficiary to use a shared public kiosk to contact the agent, agency, or carrier. A second alternative to the consumer/beneficiary's own mobile device is for the consumer/beneficiary to use a software application on a smart television or run on a home personal computer.

The platform can include a method for arranging an appointment at a later time with a remote agent.

An object of the invention is to provide a fast, easy, and convenient insurance enrollment process.

An object of the invention is to provide an enrollment platform that operates twenty-four hours per day while requiring a minimal amount of staffing.

A further object of the invention is to provide a platform for enrolling in insurance that enables the following processes:
Comparing coverage options;

Making an in-home appointment;

Sending a scope of appointment;

Visiting virtually via video with a tele agent;

Accessing the platform on a kiosk or downloadable application (i.e., “App”); and

Providing a FAQ knowledge center.

The invention encompasses a kiosk. The kiosk provides a terminal for accessing a platform for enrolling in an insurance policy. The kiosk can include blood pressure monitor for measuring a customer's blood pressure. The blood pressure reads blood pressure of the customer and transmits the blood pressure to the terminal. The terminal provides the blood pressure of the patient in order to qualify the customer for a particular policy,

The kiosk can include additional devices for collecting data on the customer to qualify the customer for a given insurance policy.

The kiosk can include a speaker, a microphone, and a camera connected to the terminal. The speaker, the microphone, and the camera can be used to form a voice or video conference with an agent. The agent can be remote from the kiosk. The agent can enroll the customer in an insurance plan based on information given by the customer during the teleconference. The agent can provide the customer with a set of insurance policies based on the information given by the customer and then the customer can select a particular policy from the set.

The invention includes downloadable software that can access the online enrollment platform. Applications for smartphones, tablets, personal computers, and set-top boxes can be provided.

The platform provides a set of agents to the customer. The agents can provide personal criteria about themselves: for example, age, gender, and language preference, cultural affinity, agent rating, location, and availability. The customer can select a particular agent from the set of agents based on the criteria.

An object of the invention is to reduce churn and to increase customer retention. To prevent a customer from being bombarded by multiple agencies, a customer will be asked to join the Do Not Call List during the enrollment process. If the customer choses, the platform will submit the customer's number for addition to the Do Not Call List.

In accordance with the objects of the invention, a method for offering health insurance to a consumer includes the following steps. The first step is providing a database of independent insurance agents. The database includes an identity field for storing a unique identity for each of the independent insurance agents. The database includes a criterion field for storing a criterion describing each of the independent insurance agents. Accordingly, a first record has a first unique identifier identifying the first independent agent stored in an identity field of the first record and a first criterion describing the first independent agent stored in a criterion field of the first record. The database further includes a second record associated with a second independent agent. The second record having a second unique identifier identifying the second independent agent stored in an identity filed of the second record and a second criterion describing the second independent agent stored in a criterion field of the second record. The next step is receiving an inquiry for health insurance from a consumer on a computer (typically a server). The computer being connected to the database. The next step is transmitting the first criterion and the second criterion from the computer to a downloadable software application of the consumer over a network (typically, the Internet). The next step is receiving an agent selection from the consumer. The agent selection is made by the consumer and depends on a selection of one of the first criterion and the second criterion by the consumer. The next step is connecting, to the consumer, a selected agent. The next step is transmitting an offer for health insurance to the consumer from the selected agent. The selected agent can send multiple, different offers to the consumer that can be provided from different underwriters.

In accordance with the objects of the invention, after the customer selects an independent insurance agent, the independent insurance agent can transmit a compliance document to the consumer and require the consumer to read, acknowledge, and accept the compliance agreement. The compliance agreement can be stored by the independent insurance agent.

In accordance with the objects of the invention, a method offers health insurance to a consumer. The first step is transmitting a downloadable software package of an independent insurance agent to a consumer of healthcare. The consumer installs the downloadable software package on the customer's smart device such as a computer, smartphone, tablet, or smart television. The next step is receiving an inquiry for health insurance for the consumer from the downloadable software package with a computer of the independent insurance agent. The next step is transmitting an offer for a health insurance policy from said computer of the independent insurance agent to said downloadable software package.

In accordance with the objects of the invention, a system offers health insurance to a consumer. The system can include a kiosk. The kiosk includes a computer, a medical instrument, and a network interface controller. The input device is connected to the computer for receiving input from the consumer. The display is connected to the computer and is used for displaying output from the consumer. The medical instrument is for measuring health data of the consumer. Examples of medical instruments include a sphygmomanometer and a scale for measuring a patient's weight. The network interface controller connects the computer to a network and transmits the input and the health data to an independent insurance agent via the network.

Although the invention is illustrated and described herein as embodied in a method for enrolling in insurance, a kiosk for enrolling in insurance, and a computer software product for enrolling in health insurance, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying examples.

### BRIEF DESCRIPTION OF THE SEVERAL VIEWS OF THE DRAWING

FIGS. 1A-1D is a flowchart showing a preferred embodiment of a method for enrolling a consumer in a downloadable software application for enrolling in health insurance.

FIG. 2 is a flowchart showing a preferred embodiment of a method for using a downloadable software application for enrolling in health insurance.

FIG. 3 is a schematic view of a system for enrolling a consumer in a health insurance policy.

FIG. 4 is a table showing a database of independent agent.

### DETAILED DESCRIPTION OF THE INVENTION

The invention of an integrative application that provides a mobile, efficient, and convenient way to engage in the insurance and health insurance marketplace for actors. This innovative concept empowers consumers in the enrollment process by providing them with added convenience, and the ability to fully self-enroll or engage with an agent/agency.

Consumers/beneficiaries can self-enroll or choose an agent to help complete their enrollment remotely via text chat, video chat, or send a scope of appointment for an in-person consult with the added benefit of selecting an agent based on: Language preference, cultural affinity, agent ratings and metrics, location, and availability (hours of operation, willingness to provide an in-home visit, office location).

A preferred embodiment of the software application streamlines the process of insurance enrollment for consumers/beneficiaries providing a simple, convenient way to enroll in a plan and limits the unwanted solicitations that can come from the traditional enrollment process as it empowers them to self-enroll and perform price comparisons or choose to work with an agent/agency of their preference.

A preferred embodiment of the software application streamlines the process for agents, who will benefit from having live, direct, exclusive leads, without the involvement of lead-vendors, saving on related costs, reducing churn and unqualified leads, increasing retention, and addressing Telecommunications Consumer Protections (TCP.) Additionally, qualified agents can be contracted with multiple carriers all on our platform allowing them to increase their reach.

A preferred embodiment of the application solves efficiency and staffing issues for agencies by providing a platform where agents, consumers and agencies can connect easily in the marketplace through our innovative integration.

A preferred embodiment of a kiosk running the software application can provide another opportunity for carriers, agencies, agents, and consumers to engage in the marketplace.

A preferred embodiment is a software application that avoids lead generators.

Qualified agents can be contracted with multiple carriers.

Clients can enroll or make an appointment with a kiosk.

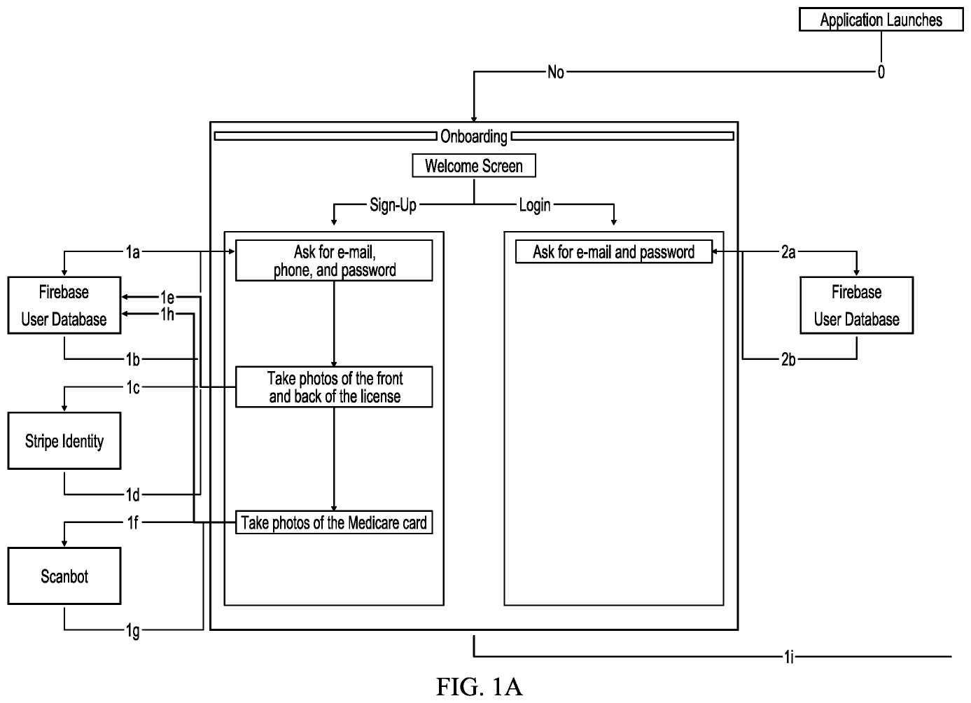

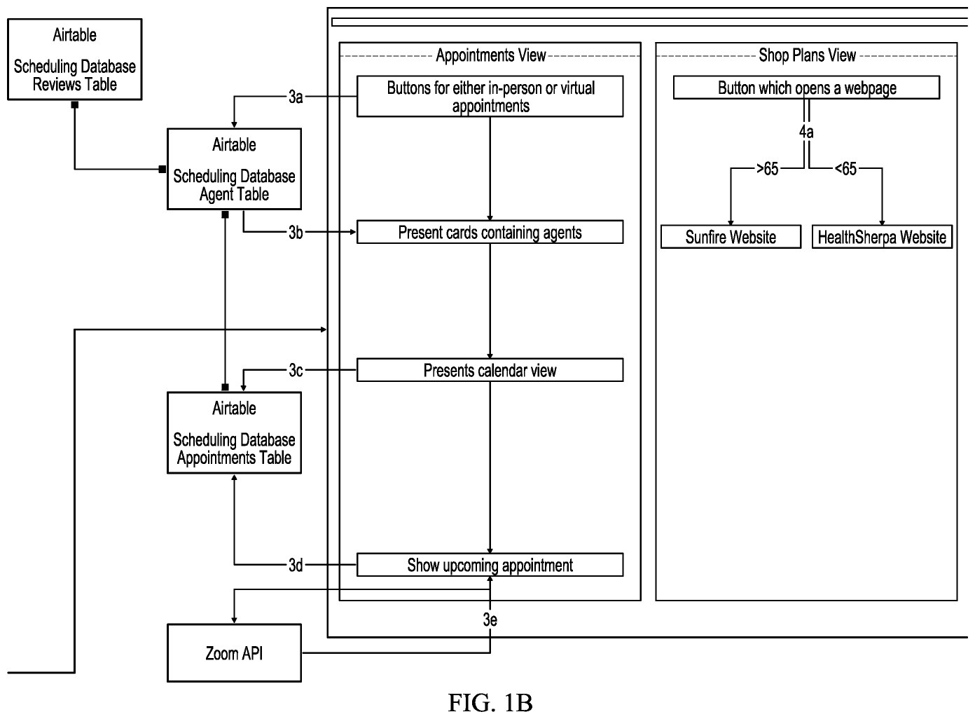

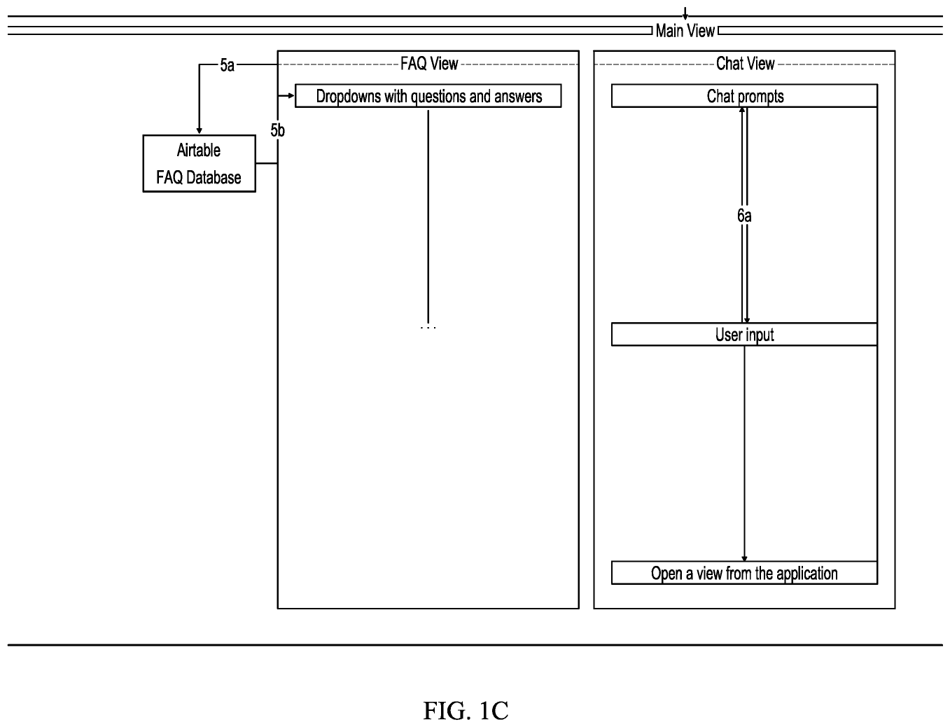

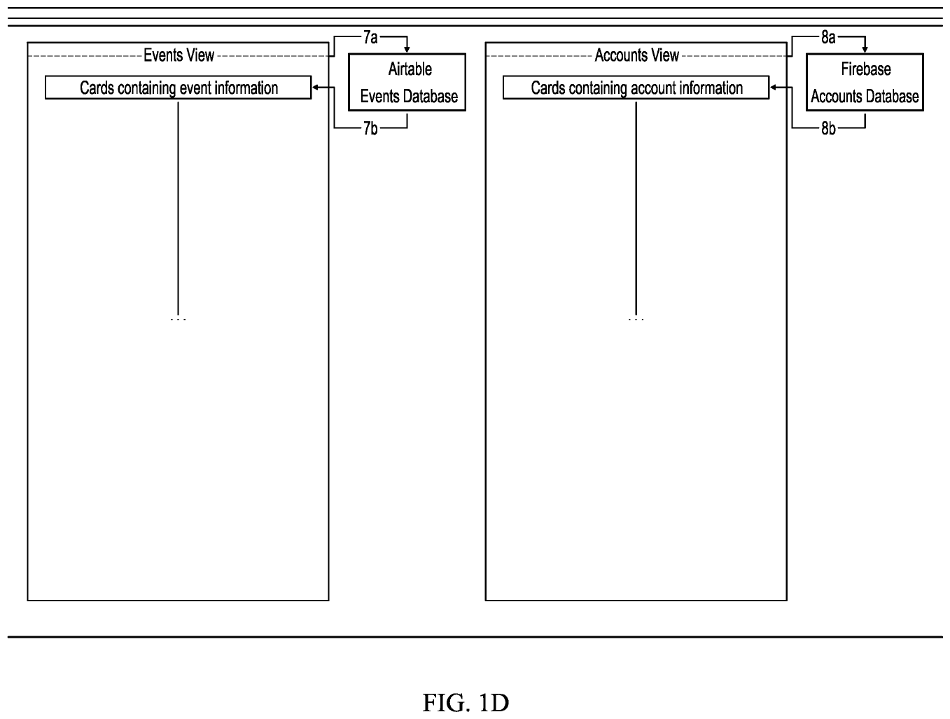

FIGS. 1A-1D depict a method executed in a downloadable software application.

Step 10 is an onboarding step that executes after the application launches. In step 1, the application checks whether the user has previously logged in or not when the application launches.

Sign-Up View 1a. Send the user input to the FIREBASE database using a REST API.

1b. If the e-mail does not exist, allow the user to proceed. Otherwise, provide feedback as to why the initial account creation failed (e-mail or phone number already exists, passwords inputted do not match, etc.).

1c. Send the photos of the front and back of the license to Stripe Identity using a REST API.

1d. If the license is valid, it will return the individuals information (address, name, age, date of birth, etc.). If an error occurs or the license is invalid, return feedback to the user as to why.

1e. Send the information obtained from Strip Identity to the Firebase user database. The information is associated to an account using the accounts auto generated uuid from Firebase.

1f. Send photos of the front of the Medicare card to Scanbot.

1g. The Scanbot service returns the information obtained from the Medicare card (name, Medicare number, etc.).

1h. Send the information obtained from Scanbot to the Firebase user database. The information is associated to an account using the accounts auto generated uuid from Firebase.

1i. Segue to the Main view.

Login View 2a. Send the user input to the Firebase database.

2b. Provide feedback as to why the user's attempt to login has failed or login.

1i. Segue to the Main view.

Main View Appointments View 3a. The user selects either in-person or virtual appointment.

3b. Available agents are obtained along with their photo, languages they speak, and average client rating. Then, a calendar view is presented with available dates and allows the user to select a date which then shows available time slots.

3c. When an appointment is confirmed, it is added to the database and linked to a given agent.

3d. The appointment card allows the user to cancel an appointment if they wish to and will update the appointments table. If the appointment has passed and it is marked as completed, it will ask the user for a review of their experience.

3e. An upcoming appointment card is shown with the Zoom link (obtained from the Zoom API) if it is a virtual appointment and sent to the appointments table. Shop Plans View

4a. Based on the information obtained during account creation, the user is presented with a button which opens a webpage. If they are over 65 then it will open the Sunfire website, if they are under 65, then it will open the HealthSherpa website. FAQ View

5a. When the FAQ view appears, the questions and answers to present are obtained from Airtable using a REST API. 5b. Based on the number of questions and answers in the database, dropdown menus are recursively created to present to the user. Chat View

6a. Chat prompts are provided to the user which allows them to select options based on user input and would either open a view or provide additional prompts to go through.

Events View 7a. When the Events view appears, the information for events is obtained from Airtable using a REST API and are filtered based on the date (only those after the current date). 7b. Based on the events available, cards are created recursively containing the title of the event, the date, a description, and a button containing the address which opens directions to the event using the default navigation application for the phone.

Accounts View 8a. When the Accounts view appears, the information for the users account is obtained from Firebase. 8b. Cards containing account information are logically grouped together (i.e., personal information, account information, address information, insurance information, etc.).

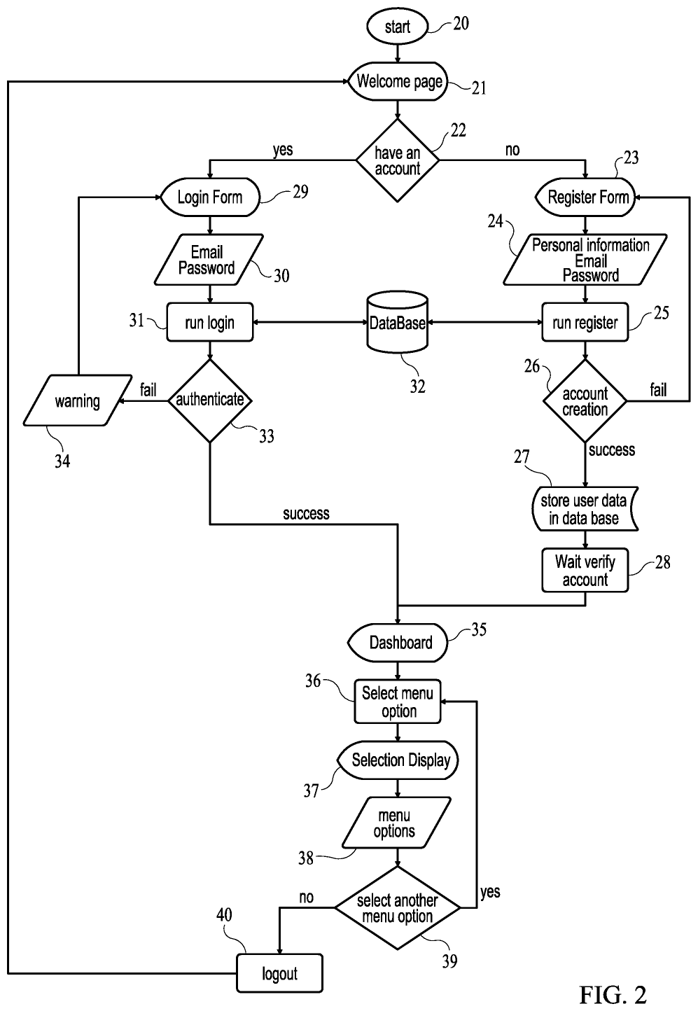

FIG. 2 is a flowchart showing a method for using a downloadable software application to enroll in a health insurance policy. Step 20 is a start of the method. In step 21, a welcome page is displayed. In step 22, the application queries the customer whether the customer has an account. If the customer does not have an account, in step 23, the application displays a registration form. In step 24, personal login information (e.g., email and password) is stored. In step 25, the application submits the personal login information for creation of an account in a database 32. In step 26, the account creation is confirmed. If the account failed to create, then the application returns to step 23. If the account is successfully created, in step 27, then the customer's personal login information is stored in a database. After creating the account, in step 28, the customer verifies the account. After the account is verified, in step 35, the application displays a dashboard. Returning to step 22, if the customer has an account, in step 29, the application displays a login form. In step 30, the customer enters the customer's personal login information. In step 31, the application runs a login procedure that logs in the customer by matching the customer information in the database 32. In step 33, the application checks that the customer has been authenticated. If the customer is not authenticated, a warning 34 is displayed and the customer is returned to the login form 29. If the customer is authenticated, the application displays the dashboard 35. In step 36, the customer selects a menu option from the dashboard 35. In step 37, the application displays the selection. In step 38, the application displays menu options. After selecting menu options, in step 39, the application returns to the select menu option step 36. If the application does not choose another menu option, in step 40, the applications logs out the customer.

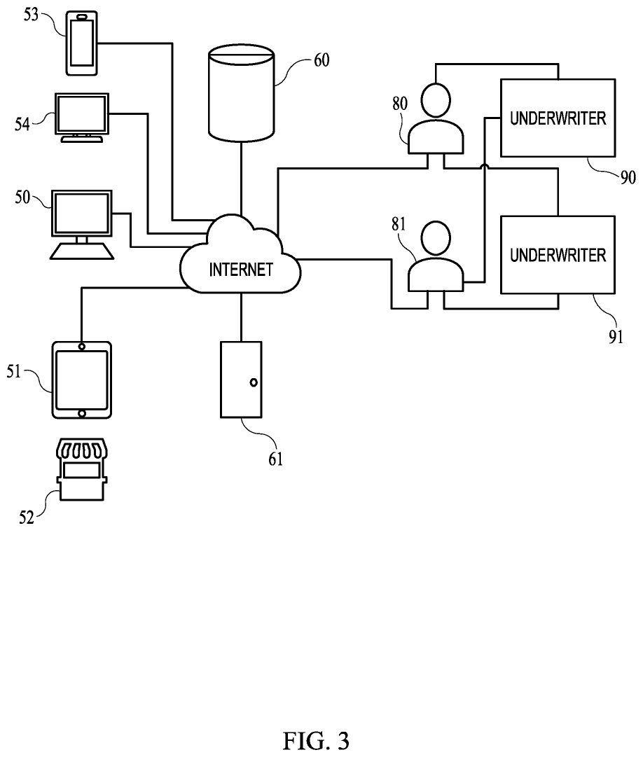

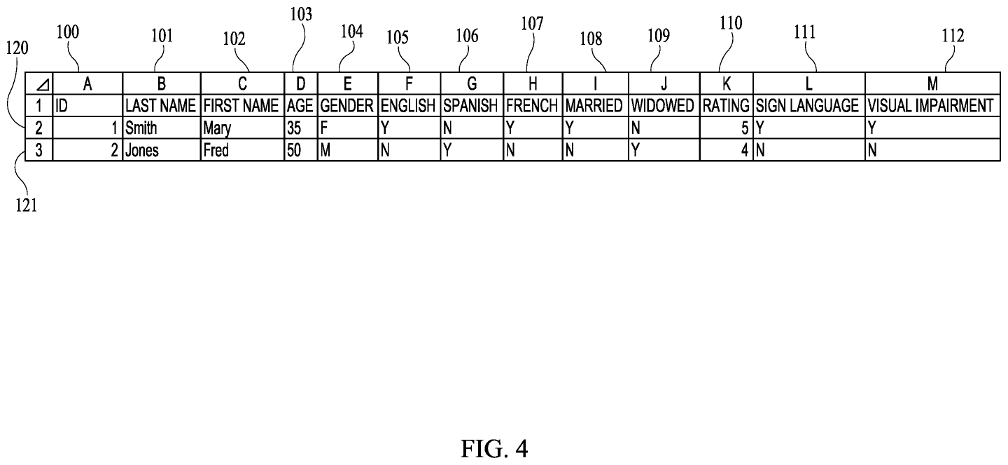

FIG. 3 show a preferred embodiment of a system purchasing health insurance. The system includes a database 60 of independent insurance agents. A preferred embodiment of the database is shown in FIG. 4. The database 60 includes an identity field 100 for storing a unique identity for each of the independent agents. The database 60 includes a last name field 101, a first name field 102, and various criterion fields that describe each independent agent. The criterion fields that are shown are age 103, gender 104, English 105 for English fluency, Spanish 106 for Spanish fluency 107, married 108, widowed 109, rating 110, sign language 111, and visual impairment 112. A first record (i.e., row) 120 describes a first independent agent. A second record 121 describes a second independent agent. A consumer uses a computer 50, tablet 51, kiosk 52, smartphone 53, or smart television 54 to connect to a server 61 via the Internet 70. A downloadable application (i.e., “application”) for enrolling in a health insurance plan is installed on each of the computer 50, tablet 51, kiosk 52, smartphone 53, or smart television 54. The customer uses the application to connect to the server 61. A list of available independent agents 80 and 81 who are registered in the database 60 can be searched by the customer. The customer enters at least one criterion and the database 60 is searched for matching records and displayed in the application. The customer selects the independent agent 80 or 81 that the customer prefers. The application connects the customer to the independent agent 80 or 81 for a video chat. If the customer is comfortable with the independent agent 80 or 81, the customer provides the customer's health information to the selected agent. By default, the customer's health insurance is not shared with unselected independent agents and the customer's health information is not saved, except by the selected independent agent 80 or 81. With the health information, the independent agent 80 or 81 finds available policy(ies) from underwriter 90 and/or 91 and offers the health insurance policies to the customer. If the consumer accepts the offer, a payment is made electronically. Before allowing the offer to be accepted, the consumer is asked to read, acknowledge, and sign a compliance statement. The compliance statement is sent and stored in the server 61. Because the agents 80 and 81 are independent agents, as opposed to captive agents, the agents 80 and 81 can provide health insurance policies from different underwriters 90 and 91. After the health insurance policy is issued, the consumer's telephone number is enrolled in a do-not-call list. Additional information is placed in a do-not-contact or non-solicitation list.

A preferred embodiment of a kiosk includes a publicly accessible tablet. The tablet includes a video camera, microphone, and speaker. A sphygmomanometer is connected to the tablet. The sphygmomanometer measures blood pressure of the consumer to add to the health information of the consumer. The additional health information is used to qualify the consumer to health insurance policies.

A preferred embodiment of a terminal of an independent insurance agent includes a computer. A network interface controller connects the computer the Internet. The terminal is used to make a video call connection to the customer and to receive health information from the application and to send health insurance policy offers to the application of the consumer.

What is claimed is:

1. A method for offering health insurance to a consumer, which comprises:
providing a database of independent insurance agents, said database including an identity field for storing a unique identity for each of the independent insurance agents and a criterion field for storing a criterion describing each of the independent insurance agents, a first record associated with a first independent agent, the first record having a first unique identifier identifying the first independent agent stored in an identity field of said first record and a first criterion describing the first independent agent stored in a criterion field of the first record, and a second record associated with a second independent agent, the second record having a second unique identifier identifying the second independent agent stored in an identity filed of said second record and a second criterion describing the second independent agent stored in a criterion field of said second record;
receiving an inquiry for health insurance from a consumer on a computer, said computer being connected to said database;
transmitting said first criterion and said second criterion from said computer to the consumer over a network;
receiving an agent selection from the consumer, said agent selection depending on a selection of one of said first criterion and said second criterion by the consumer;
connecting, to the consumer, a selected agent, the selected agent being one of said first independent agent and said second independent agent based on said agent selection; and
transmitting an offer for health insurance to the consumer from the selected agent.

2. The method according to claim 1, which further comprises:
transmitting a further offer for health insurance to the consumer from the selected agent; and
receiving a policy selection of one of said offer and said further offer from the consumer.

3. The method according to claim 2, wherein:
said offer for health insurance is from a first underwriter; and
said further offer for health insurance is from a second underwriter.

4. The method according to claim 1, which further comprises the selected agent submitting a telephone number of the consumer to a do not call list.

5. The method according to claim 1, which further comprises:
transmitting a compliance confirmation request from the selected agent to the consumer; and
receiving a compliance confirmation replying to the compliance confirmation request from the consumer.

6. A method for offering health insurance to a consumer, which comprises:
transmitting a downloadable software package of an independent insurance agent to a consumer of healthcare;
receiving an inquiry for health insurance for the consumer from said downloadable software package with a computer of the independent insurance agent; and
transmitting an offer for a health insurance policy from said computer of the independent insurance agent to said downloadable software package.

7. The method according to claim 6, which further comprises:
providing a database of independent insurance agents, said database including an identity field for storing a unique identity for each of the independent insurance agents and a criterion field for storing a criterion describing each of the independent insurance agents, a first record associated with a first independent agent, the first record having a first unique identifier identifying the first independent agent stored in an identity field of said first record and a first criterion describing the first independent agent stored in a criterion field of the first record, and a second record associated with a second independent agent, the second record having a second unique identifier identifying the second independent agent stored in an identity filed of said second record and a second criterion describing the second independent agent stored in a criterion field of said second record;
transmitting said first criterion and said second criterion from said computer to the consumer over a network;
receiving an agent selection from the consumer, said agent selection depending on a selection of one of said first criterion and said second criterion by the consumer; and
connecting, to the consumer, a selected agent, the selected agent being one of said first independent agent and said second independent agent based on said agent selection.

8. The method according to claim 7, which further comprises:
transmitting a further offer for health insurance to the consumer from the selected agent; and
receiving a policy selection of one of said offer and said further offer from the consumer.

9. The method according to claim 8, wherein:
said offer for health insurance is from a first underwriter; and
said further offer for health insurance is from a second underwriter.

10. The method according to claim 6, which further comprises the independent insurance agent submitting a telephone number of the consumer to a do not call list.

11. The method according to claim 7, which further comprises:
transmitting a compliance confirmation request from the selected agent to the consumer; and
receiving a compliance confirmation replying to the compliance confirmation request from the consumer.

12. A system for offering health insurance to a consumer, comprising:
a kiosk for requesting healthcare insurance, said kiosk including a computer, an input device being connected to said computer for receiving input from the consumer, a display being connected to said computer for displaying output from the consumer, a medical instrument for measuring health data of the consumer, and a network interface controller for connecting to a network and transmitting the input and the health data to an independent insurance agent.

13. The system according to claim 12, further comprising:
a terminal of an independent insurance agent including a computer, a network interface controller for connected said computer to the network; and
said computer receiving the health data from said kiosk.

14. The system according to claim 12, wherein said input device is a keyboard.

15. The system according to claim 12, wherein said display shows video sent from the independent insurance agent.

16. The system according to claim 12, wherein said kiosk includes a camera for recording video of the consumer.

17. The system according to claim 12, wherein said medical instrument is a sphygmomanometer for measuring blood pressure of the consumer.
